(19) United States
(12) Patent Application Publication
(10) Pub. No.: US 2026/0058834 A1
(43) Pub. Date: Feb. 26, 2026

(54) METHOD AND SYSTEM FOR AN AUDITABLE, AI-DRIVEN SAFETY MANAGEMENT AND REGULATORY COMPLIANCE SYSTEM FOR AVIATION OPERATIONS

(71) Applicant: Richard Joseph Mitchell, TAVARES, FL (US)

(72) Inventor: Richard Joseph Mitchell, TAVARES, FL (US)

(21) Appl. No.: 19/377,012

(22) Filed: Nov. 2, 2025

(51) Int. Cl. H04L 9/00; G06Q 50/26

(52) U.S. Cl. CPC H04L 9/50; G06Q 50/265; H04L 2209/84

(57) ABSTRACT

A computer-implemented system and method for managing aviation safety and regulatory compliance are disclosed. Operational data, including flight logs and maintenance records, is ingested and secured into a Cryptographically Immutable Ledger to create a permanent, tamper-proof evidentiary record having discrete time indices. A repository stores versions of safety rules, with each version cryptographically time-stamped to its period of effect. An Artificial Intelligence (AI) Analysis Engine executes a Synchronic Correlation Audit. The audit retrieves a specific historical data state from the ledger corresponding to a queried time index and simultaneously retrieves the exact version of the rules that was in effect at that same time index. The engine analyzes the historical data exclusively against the time-corresponding rules to provide a verifiable, historically precise compliance assessment. The system enables proactive risk identification and automates the generation of auditable compliance reports.

### BACKGROUND OF THE INVENTION

### 1. Field of the Invention

The present invention relates generally to the field of aviation safety and regulatory compliance, and specifically to a computer-implemented system and method for automating, managing, and verifying compliance with strict aviation regulations, such as those governing uncrewed aircraft systems (UAS) operations, through the use of an artificial intelligence engine integrated with a cryptographically immutable data ledger.

### 2. Description of the Related Art

The operation of UAS and other aviation activities is subject to stringent regulatory oversight, often necessitating the implementation of a formal Safety Management System (SMS). The “Safety Assurance” component of an SMS requires continuous monitoring of operations, analysis of safety performance data, and proactive identification of emerging risks.

Existing systems for managing operational data in aviation rely on conventional, mutable databases and disparate software tools for logging flights, tracking maintenance, and managing personnel records. This current state of technology suffers from several critical, technical deficiencies that compromise regulatory compliance and safety assurance: Q Data Fragmentation and Manual Burden: Operational data is scattered across incompatible systems, necessitating time-consuming, manual data collection and analysis for auditing and reporting, which is highly prone to human error.
Lack of Technical Verifiability: Data stored in conventional databases can be altered, deleted, or otherwise tampered with without detection. This technical flaw makes it impossible to establish an unimpeachable, forensically sound record of events during an incident investigation or regulatory audit.
Absence of Historical Context Integrity: Traditional compliance software checks current operations against current rules. Such systems cannot technically reconstruct the exact state of historical operational data and accurately judge it against the specific version of policies and regulations that were in force at that precise past moment. This deficiency prevents fair and accurate post-incident or historical compliance analysis.

Therefore, a critical technical need exists for a unified, automated, and mathematically verifiable system that overcomes the fundamental flaws of data mutability and historical context degradation inherent in the prior art. No prior art system known to the inventor provides for a historically precise compliance audit that cryptographically locks operational data to the specific regulatory state that was in effect at the moment of operations.

### BRIEF SUMMARY OF THE INVENTION

The present invention provides a novel computer-implemented system and method that solves the technical problem of ensuring historical context integrity and data verifiability in regulated environments. The invention is directed to a specific architecture and a novel audit process, termed a “Synchronic Correlation Audit,” which establishes a forensically verifiable and historically precise compliance assessment.

The system secures safety-critical operational data into a Cryptographically Immutable Ledger, preferably implemented as a private, permissioned distributed ledger, to create a permanent, tamper-proof evidentiary record with discrete historical time indices. Concurrently, the system maintains a time-indexed rule repository where each version of a safety rule or regulation is cryptographically time-stamped to its specific period of legal effect.

The core inventive feature is an Artificial Intelligence (AI) Analysis Engine configured to execute the Synchronic Correlation Audit. In response to a query specifying a single historical time index, the engine is configured to retrieve, from the immutable ledger, the specific set of historical operational data corresponding only to the queried time index. Simultaneously, the engine retrieves, from the time-indexed rule repository, the specific version of the safety rules that was in effect at that same time index. The engine then analyzes the retrieved historical data exclusively against the retrieved, time-corresponding version of the rules to determine a compliance status for that discrete past point in time.¹

This synergistic combination of two distinct, time-indexed data structures with a specialized AI analysis process provides a non-obvious technical solution that overcomes the static rule application and data mutability limitations of the prior art.

### BRIEF DESCRIPTION OF THE SEVERAL VIEWS OF THE DRAWING

FIG. 1 is a system architecture diagram illustrating the major technical components of the Auditable Compliance & Safety Management System (100), including the Data Ingestion Module (110), the Cryptographically Immutable Ledger (120), the AI Analysis Engine (130), and the User Interface & Reporting Module (140).

FIG. 2 is a data flow diagram showing the process of ingesting operational data from various sources, securing it within the immutable ledger, and processing it with the AI Analysis Engine (130).

FIG. 3 is a process flowchart illustrating the Synchronic Correlation Audit function, showing how the system retrieves a historical state from the immutable ledger (120) and compares it against time-stamped versions of regulations and safety manuals.

FIG. 4 is an exemplary user interface dashboard, showing proactive safety alerts, compliance status indicators, and key safety performance indicators (SPIs) derived from the verifiable data.

### DETAILED DESCRIPTION OF THE INVENTION

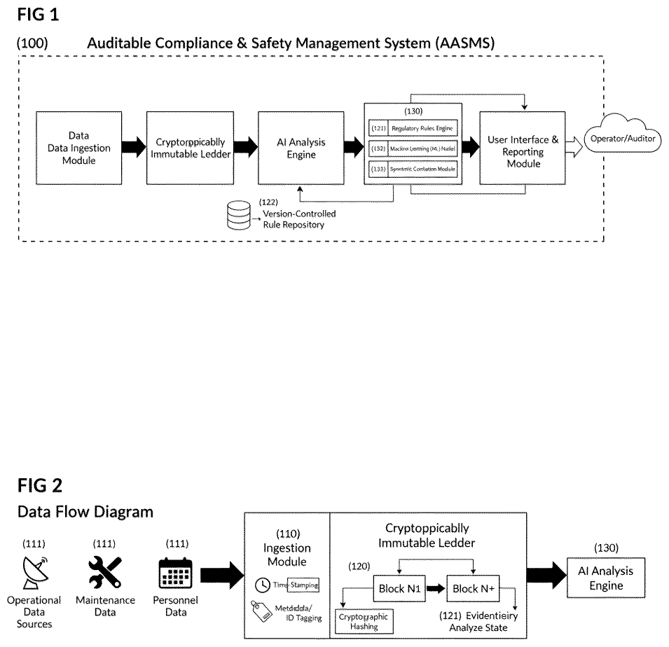

Referring now to FIG. 1, the Auditable Compliance & Safety Management System (AASMS) (100) comprises four primary, integrated modules: a Data Ingestion Module (110), a Cryptographically Immutable Ledger (120), an AI Analysis Engine (130), and a User Interface & Reporting Module (140).

### 1. Data Ingestion Module (110)

The Data Ingestion Module (110) serves as the secure interface for collecting all relevant operational data from a variety of sources within the aviation operator's environment. The data sources include, but are not limited to: Flight Operations (telemetry, command-and-control (C2) link performance), Maintenance Records, Personnel Records (certifications, training), Incident Reports, and Regulatory & Policy Documents. Each piece of data is digitally authenticated and associated with relevant metadata and a precise time-stamp prior to being passed to the ledger.

### 2. Cryptographically Immutable Ledger (120) and Version-Controlled Rule Repository

As shown in FIG. 2, all operational data collected by the Ingestion Module (110) is passed to the Cryptographically Immutable Ledger (120). The ledger is preferably implemented using private, permissioned distributed ledger technology (DLT). This architecture ensures immutability, where Each data entry is treated as a transaction, cryptographically hashed, grouped into blocks, and chronologically linked using the hash of the previous block. Once a record is written, any attempt to alter it would break the cryptographic chain, making the tampering mathematically detectable. This structure provides a mathematical proof of the data's integrity and chain of custody, creating the tamper-proof evidentiary record essential for post-incident investigation.

A key component of the system is the Version-Controlled Rule Repository, which stores digital representations of the operator's Safety Management System (SMS) manual, Standard Operating Procedures (SOPs), and applicable government regulations (e.g., 14 C.F.R. Part 108). each version of a regulatory or policy document is ingested as a digital file (e.g., PDF or XML). A cryptographic hash of the document is generated, and this hash, along with the document's effective start and end dates, is recorded as a transaction in a dedicated channel of the Cryptographically Immutable Ledger (120). This process mathematically time-locks each version, creating a permanent, auditable link between a specific rule set and its period of legal effect. This creates a time-indexed rule repository wherein each rule version is cryptographically secured to a specific time-stamp of regulatory effect.

### 3. AI Analysis Engine (130)

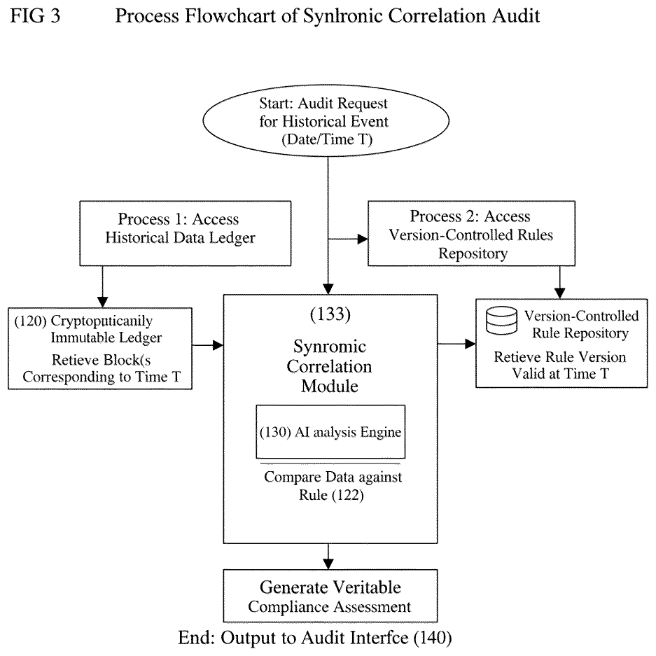

The AI Analysis Engine (130) is the intelligence hub executed by the system's processor, continuously monitoring the immutable data stream. The engine comprises a Regulatory Rules Engine, a Machine Learning (ML) Model, and a Synchronic Correlation Module.
Machine Learning Model Implementation: The ML model is trained to proactively identify complex patterns and anomalies indicating emerging safety risks. The model's feature engineering leverages the integrity of the DLT by analyzing novel technical input features such as cryptographic hash stability, temporal block linkage integrity, and verifiable chain-of-custody metadata. For instance, the cryptographic hash stability may be calculated as the statistical variance of the time delta between consecutive blocks containing data for a specific aircraft asset over a rolling window. A sudden increase in this variance could be used as a feature indicating potential data transmission or logging irregularities. Suitable models for this task may include Long Short-Term Memory (LSTM) networks for analyzing time-series telemetry data or Isolation Forest algorithms for anomaly detection.
Synchronic Correlation Module: As detailed in FIG. 3, this module executes the historical context integrity function. When an auditor or system process initiates an audit for a specific past event, this module retrieves the relevant data blocks from the Immutable Ledger (120) and simultaneously queries the Version-Controlled Rule Repository to pull the exact regulatory and policy versions that were in effect at the specific moment in question. The AI engine then performs its analysis using this historically accurate, dual-secured context, ensuring a fair and mathematically precise compliance assessment.

### 4. User Interface & Reporting Module (140)

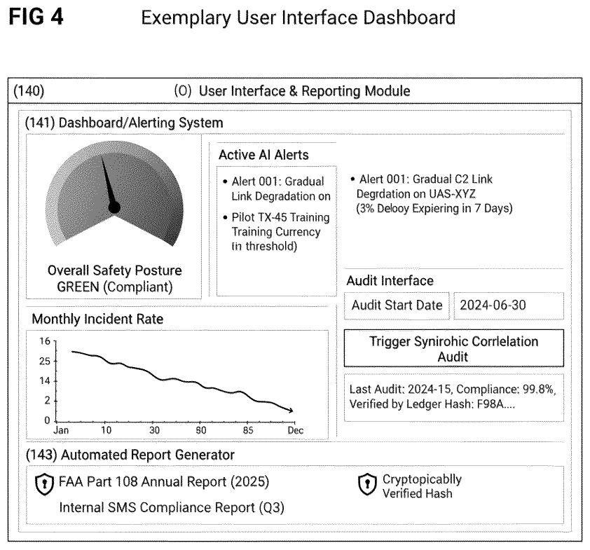

This module provides the necessary human interface, as shown in the exemplary interface of FIG. 4. It provides a real-time Dashboard displaying Key Performance Indicators (KPIs) and Safety Performance Indicators (SPIs). The Audit Interface allows an administrator or auditor to trigger the Synchronic Correlation Audit for any past event. Furthermore, the Automated Report Generator automatically produces all required FAA compliance reports. Because every data point underlying these reports is backed by a verifiable, cryptographic chain of custody from the ledger (120), the reports carry an inherent and verifiable high degree of integrity and trustworthiness.

What is claimed is:

1. A computer-implemented method for verifiable management of aviation safety and regulatory compliance, the method comprising:
(a) Ingesting, by a data ingestion module, operational data from a plurality of aviation-related sources;
(b) Generating, by a processor, a cryptographically immutable ledger comprising said operational data, wherein each data entry is treated as a transaction, cryptographically hashed, and chronologically linked into blocks to establish a tamper-proof evidentiary state having a plurality of historical time indices;
(c) Storing a plurality of version-controlled digital representations of safety rules and government regulations in a secure repository, wherein each version is cryptographically time-stamped to a specific period of regulatory effect, thereby creating a time-indexed rule repository; and
(d) Executing, by the processor, an Artificial Intelligence (AI) Analysis Engine to perform a Synchronic Correlation Audit in response to a query specifying a single historical time index, the audit comprising:
(i) retrieving, from the immutable ledger, a specific set of historical operational data corresponding only to the queried historical time index;
(ii) simultaneously retrieving, from the time-indexed rule repository, the specific version of the safety rules and government regulations having a period of effect that includes the queried historical time index; and
(iii) analyzing the retrieved historical data exclusively against the retrieved specific version of the rules to determine a compliance status for the discrete past point in time, thereby establishing a forensically verifiable compliance assessment.

2. The method of claim 1, further comprising: continuously analyzing the data within the cryptographically immutable ledger using a Machine Learning (ML) Model, wherein the ML Model's input features include at least one metric derived from the cryptographic structure of the ledger, said metric being selected from the group consisting of hash stability, temporal block linkage integrity, and verifiable chain-of-custody metadata, to proactively identify emerging safety risks.

3. The method of claim 1, wherein the Cryptographically Immutable Ledger is a private, permissioned distributed ledger.

4. The method of claim 1, wherein the safety rules and government regulations include an aviation operator's Safety Management System (SMS) manual and regulations applicable to Uncrewed Aircraft Systems (UAS) operations.

5. The method of claim 1, further comprising: automatically generating a regulatory compliance report based on the output of the Synchronic Correlation Audit, wherein each data point in the report includes a cryptographic hash that provides a direct, verifiable link to its corresponding transaction in the immutable ledger.

6. A computer system for providing auditable aviation safety and regulatory compliance, the system comprising:
(a) A processor and a non-transitory computer readable storage medium operatively coupled to the processor;
(b) A Data Ingestion Module configured to receive and time-stamp operational data;
(c) A Cryptographically Immutable Ledger, stored on the storage medium, configured to secure said operational data using cryptographic hashing and block chaining, creating a tamper-proof, chronological evidentiary record having a plurality of historical time indices;
(d) A Version-Controlled Rule Repository configured to store and index digital representations of safety rules and government regulations according to specific time-stamps of regulatory effect; and
(e) An AI Analysis Engine, executed by the processor, wherein the engine comprises a Synchronic Correlation Module configured to:
(i) access the evidentiary record of the immutable ledger at a specific historical time index provided in a query; and
(ii) correlate the historical evidentiary record with the specific version of the safety rules and government regulations retrieved from the Version-Controlled Rule Repository that matches the historical time index, thereby generating a historically precise safety risk and compliance assessment based exclusively on the data and rules in effect at the specified historical time index.

7. The system of claim 6, wherein the AI Analysis Engine further comprises a Machine Learning (ML) Model trained to continuously monitor data in the immutable ledger and configured to use features derived from the ledger's cryptographic structure to identify patterns indicative of safety risk degradation.

8. The system of claim 6, further comprising a User Interface & Reporting Module configured to display a dashboard of real-time safety performance indicators and provide an audit interface for triggering the Synchronic Correlation Audit.

9. The system of claim 6, wherein the Cryptographically Immutable Ledger is implemented as a private, permissioned distributed ledger.

10. The system of claim 6, wherein the operational data includes telemetry data, command-and-control link performance data, and maintenance records.
